(19) United States
(12) Patent Application Publication
(10) Pub. No.: US 2026/0196893 A1
(43) Pub. Date: Jul. 9, 2026

(54) PERMANENT MAGNET ROTOR

(71) Applicant: FORD GLOBAL TECHNOLOGIES, LLC, Dearborn, MI (US)

(72) Inventor: Adam Bangerter, Dearborn, MI (US)

(21) Appl. No.: 19/008,833

(22) Filed: Jan. 3, 2025

(51) Int. Cl. H02K 1/278; H02K 15/035

(52) U.S. Cl. CPC H02K 1/278; H02K 15/035

(57) ABSTRACT

A permanent magnet synchronous motor includes a rotor with magnets inserted diagonally into magnet slots. Each magnet slot includes a set of flexible tabs to hold the magnet in position once inserted. The magnet is held by a stopper tab on one end and by a retainer tab on the opposite end. A compressor tab holds the magnet in position laterally. The magnet slots may include a tapered region to facilitate magnet insertion.

### TECHNICAL FIELD

This disclosure pertains to electric motors. More particularly, this disclosure pertains to a permanent magnet rotor with magnets retained by flexible tabs.

### BACKGROUND

Many electrified vehicles utilize permanent magnet synchronous traction motors. These motors include a rotor made from a stack of rotor plates. Each rotor plate has a set of permanent magnets installed in slots. The pattern of the slots varies between motor designs. In most cases, the magnets are inserted from an end of the rotor plate. The permanent magnets need to be constrained from moving within the rotor plates during operation of the motor. One method of securing the magnets is to add resin fill material.

### SUMMARY

A rotor plate includes a body, a plurality of stopper tabs, and a plurality of retainer tabs. The body defines a plurality of magnet slots. Each magnet slot extends diagonally from a perimeter of the body. Each magnet slot has an outer side towards the perimeter and an inner side opposite the outer side. Each stopper tab extends into one of the plurality of magnet slots. Each stopper tab may be configured to deflect along an axis of the respective magnet slot in response to complete insertion of a magnet. Each retainer tab extends into one of the plurality of magnet slots and is configured to deflect out of the magnet slot in response to partial insertion of the magnet and to return to its original position in response to complete insertion of the magnet. Each of the magnet slots may include a tapered section between the perimeter of the body and the respective retainer tabs. The stopper tabs and/or the retainer tabs may be located along the inner sides of the magnet slots. The rotor plate may also include a plurality of compressor tabs. Each compressor tab may extending into one of the magnet slots between a respective stopper tab and a respective retainer tab. Each compressor tab may be configured to deflect out of the magnet slot in response to partial insertion of the magnet and to remain out of the slot with the magnet completely inserted. The compressor tabs may be located on a same side of the magnet slots as the stopper tabs and the retainer tabs.

A rotor includes a rotor plate, a plurality of stopper tabs, a plurality of retainer tabs, and a plurality of permanent magnets. The rotor plate defines a plurality of magnet slots. Each magnet slot extends diagonally from a perimeter of the rotor plate. Each stopper tab extends from the rotor plate into one of the magnet slots. Each permanent magnet is located in one of the plurality of magnet slots abutting one of the stopper tabs. Each retainer tab extends diagonally from the rotor plate into one of the plurality of magnet slots on an opposite end of a respective one of the permanent magnets from a respective one of the stopper tabs. The stopper tabs and the retainer tabs may be integrally formed with the rotor plate. The rotor may also include a plurality of compressor tabs. Each compressor tab may be located between a respective one of the stopper tabs and one of the retainer tabs. The compressor tabs may be deflected out of the magnet slot by one of the permanent magnets. Each of the magnet slots may include a tapered section between the perimeter of the rotor plate and the retainer tab. The rotor plate may include a star-shaped portion and a plurality of wedge-shaped portions. Each wedge-shaped portion may be fixed to the star-shaped portion by a respective radial link. Each of the magnet slots may be defined between the star-shaped portions and one of the plurality of wedge-shaped portions. The rotor plate may also include a plurality of V-shaped portions between the star-shaped portion and the wedge-shaped portions.

A method of assembling a rotor includes moving a magnet into a magnet slot. In a first position, a front portion of the magnet is in a magnet slot of the rotor plate and a rear portion of the magnet extends beyond a perimeter of the rotor plate. The magnet is moved from the first position to a second position. In the second position, the front portion deflects a retaining tab out of the magnet slot. In the second position, the magnet may also deflect a compressor tab out of the magnet slot. The magnet is moved from the second position to a third position. In the third position, the front portion abuts a stopper tab while the rear portion continues to deflect the retaining tab out of the magnet slot. Pushing the magnet against the stopper tab deflects the stopper tab and the retainer tab extends into the magnet slot to prevent the magnet from sliding out of the magnet slot. In this installed position of the magnet, the compressor tab may remain deflected out of the magnet slot.

### BRIEF DESCRIPTION OF THE DRAWINGS

FIG. 1 is a block diagram of an electric vehicle.

FIG. 2 is a cross section of an electric machine suitable for use in the vehicle of FIG. 1.

FIG. 3 is pictorial view of a rotor plate suitable for use in the electric machine of FIG. 2.

FIG. 4 is an end view of the rotor plate of FIG. 3.

FIG. 5 is a detail view of the rotor plate of FIG. 4.

FIG. 6 is a view of a permanent magnet in a first position during insertion into the rotor plate of FIGS. 3-5.

FIG. 7 is a view of a permanent magnet in a second position during insertion into the rotor plate of FIGS. 3-5.

FIG. 8 is a view of a permanent magnet in a third position during insertion into the rotor plate of FIGS. 3-5.

FIG. 9 is a view of a permanent magnet in a final position during insertion into the rotor plate of FIGS. 3-5.

FIG. 10 is a flowchart for a process of fabricating a rotor.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

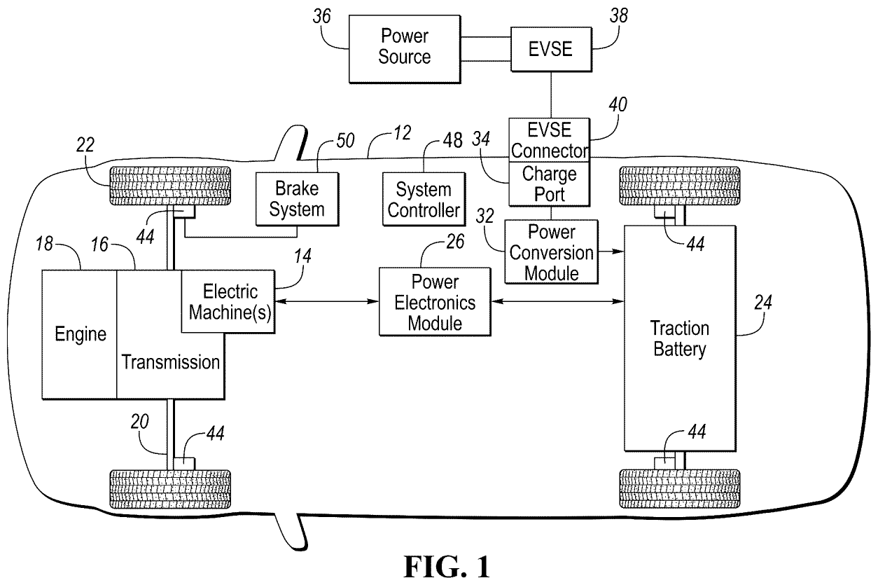

Referring now to FIG. 1, a block diagram of an exemplary electric vehicle (“EV”) 12 is shown. In this example, EV 12 is a plug-in hybrid electric vehicle (PHEV). EV 12 includes one or more electric machines 14 (“e-machines”) mechanically connected to a transmission 16. Electric machine 14 is capable of operating as a motor and as a generator. Transmission 16 is mechanically connected to an engine 18 and to a drive shaft 20 mechanically connected to wheels 22. Electric machine 14 can provide propulsion and slowing capability while engine 18 is turned on or off. Electric machine 14 may reduce vehicle emissions by allowing engine 18 to operate at more efficient speeds and allowing EV 12 to be operated in electric mode with engine 18 off under certain conditions.

A traction battery 24 (“battery) stores energy that can be used by electric machine 14 for propelling EV 12. Battery 24 typically provides a high-voltage (HV) direct current (DC) output. Battery 24 is electrically connected to a power electronics module 26. Power electronics module 26 is electrically connected to electric machine 14 and provides the ability to bi-directionally transfer energy between battery 24 and the electric machine. For example, battery 24 may provide a DC voltage while electric machine 14 may require a three-phase alternating current (AC) voltage to function. Power electronics module 26 may convert the DC voltage to a three-phase AC voltage to operate electric machine 14. In a regenerative mode, power electronics module 26 may convert three-phase AC voltage from electric machine 14 acting as a generator to DC voltage compatible with battery 24.

Battery 24 is rechargeable by an external power source 36 (e.g., the grid). Electric vehicle supply equipment (EVSE) 38 is connected to external power source 36. EVSE 38 provides circuitry and controls to control and manage the transfer of energy between external power source 36 and EV 12. External power source 36 may provide DC or AC electric power to EVSE 38. EVSE 38 may have a charge connector 40 for plugging into a charge port 34 of EV 12. Charge port 34 may be any type of port configured to transfer power from EVSE 38 to EV 12. A power conversion module 32 of EV 12 may condition power supplied from EVSE 38 to provide the proper voltage and current levels to battery 24. Power conversion module 32 may interface with EVSE 38 to coordinate the delivery of power to battery 24. Alternatively, various components described as being electrically connected may transfer power using a wireless inductive coupling.

The various components discussed may have one or more associated controllers to control and monitor the operation of the components. The controllers can be microprocessor-based devices. The controllers may communicate via a serial bus (e.g., Controller Area Network (CAN)) or via discrete conductors. For example, a system controller 48 (i.e., a vehicle controller) is present to coordinate the operation of the various components.

As described, EV 12 is in this example is a PHEV having engine 18 and battery 24 In other embodiments, EV 12 is a battery electric vehicle (BEV). In a BEV configuration, EV 12 does not include an engine.

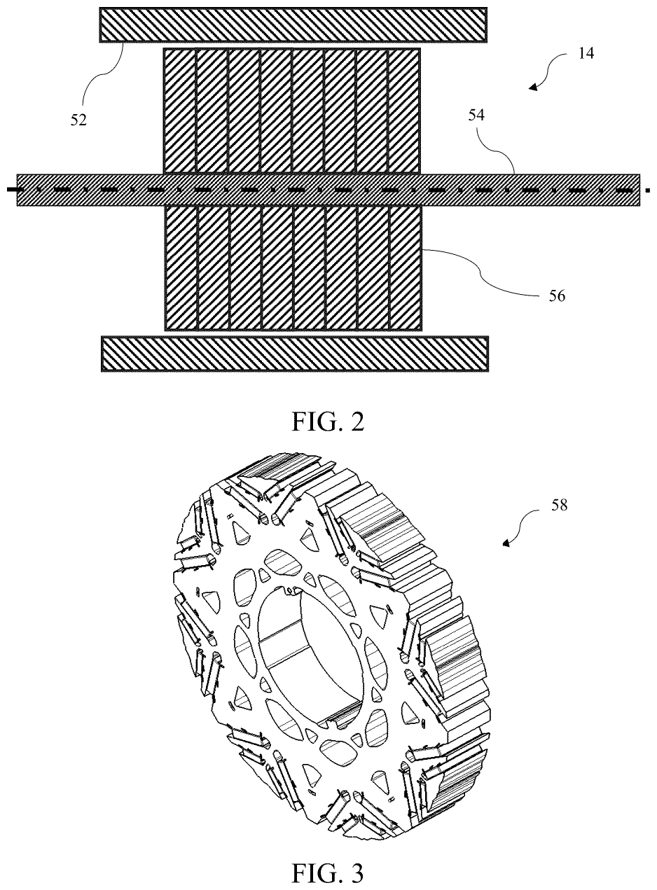

FIG. 2 illustrates electric machine 14. A stator 52 is fixed to vehicle structure. A rotor shaft 54 is supported for rotation with respect to the stator 52. A set of rotor plates 56 is fixed to the rotor shaft for rotation therewith. FIG. 3 is a pictorial view of a rotor plate body 58 of the rotor plates 56 before insertion of permanent magnets.

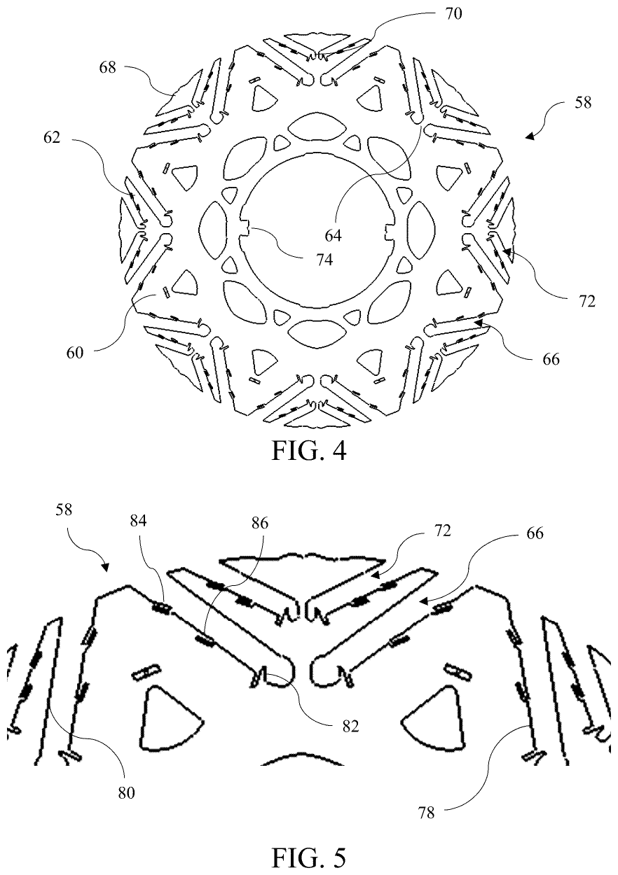

FIG. 4 is a front view of rotor plate body 58. The rotor plate body includes a star-shaped portion 60. In the illustrated example, it is an 8-pointed star. A set of V-shaped portions 62 are connected to the star-shaped portion by a set of first radial links 64. The star-shaped portion and the V-shaped portions together define a first set of magnet slots 66 that extend diagonally from the first radial links to a perimeter of the rotor plate body. A set of wedge-shaped portions 68 are connected to the V-shaped portions 62 by a second set of radial links 70. The V-shaped portions and the wedge-shaped portions together define a second set of magnet slots 72 that extend diagonally from the second radial links to the perimeter of the rotor plate body 58. The star-shaped portion, V-shaped portions, wedge-shaped portions, and radial links may be integrally formed. For example, they may be formed by fastening a set of thin laminations. In an alternative embodiment, wedge-shaped portions could be attached directly to the star-shaped portion by radial links. This alternative embodiment would have only one set of magnet slots 66 as opposed to two sets. Internal keys 74 rotationally fix the rotor plate to the rotor shaft 54.

FIG. 5 is a detailed view of the rotor plate body of FIG. 4. Each of the magnet slots 66 has an inner side 78 along the star-shaped port and an outer side 80 along the V-shaped portion. The outer side is closer to the perimeter of the rotor body than the corresponding inner side. Similarly, each of the magnet slots 72 has an inner side along the V-shaped portion and an outer side along the wedge-shaped portion. Three flexible tabs extend into each of the magnet slots. A stopper tab 82 is located closest to the respective radial link. A retainer tab 84 is located closest to the perimeter. A compressor tab 86 is located between the respective stopper tab and retainer tab. In the illustrated embodiment, all three tabs are located along the inner sides of the magnet slot. In alternative embodiments, one or more of the three tabs may be located on an outer side. Although describes here as separate components, the stopper tabs, retainer tabs, and compressor tabs may be integrally formed with the rotor body.

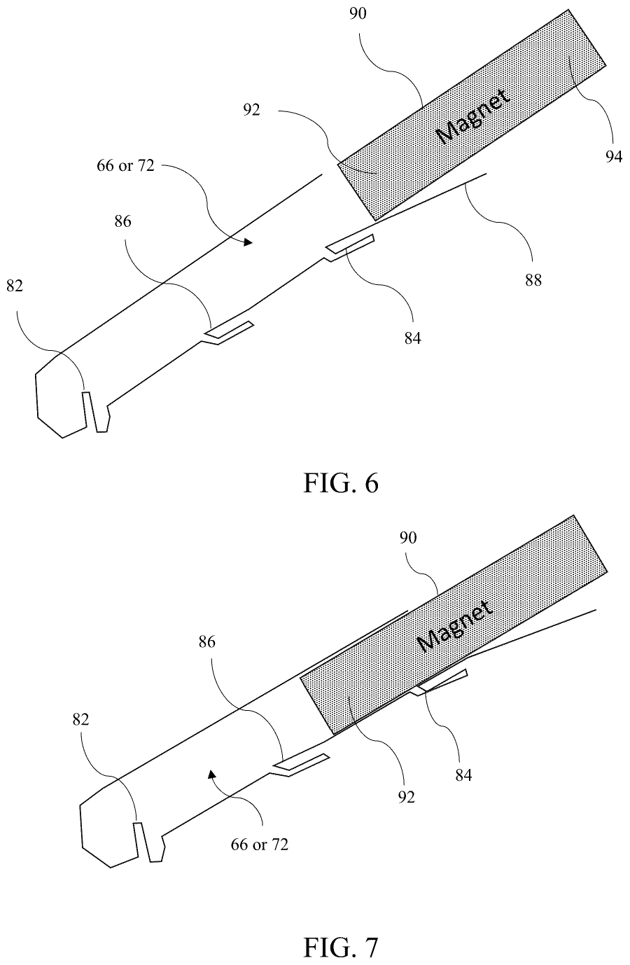

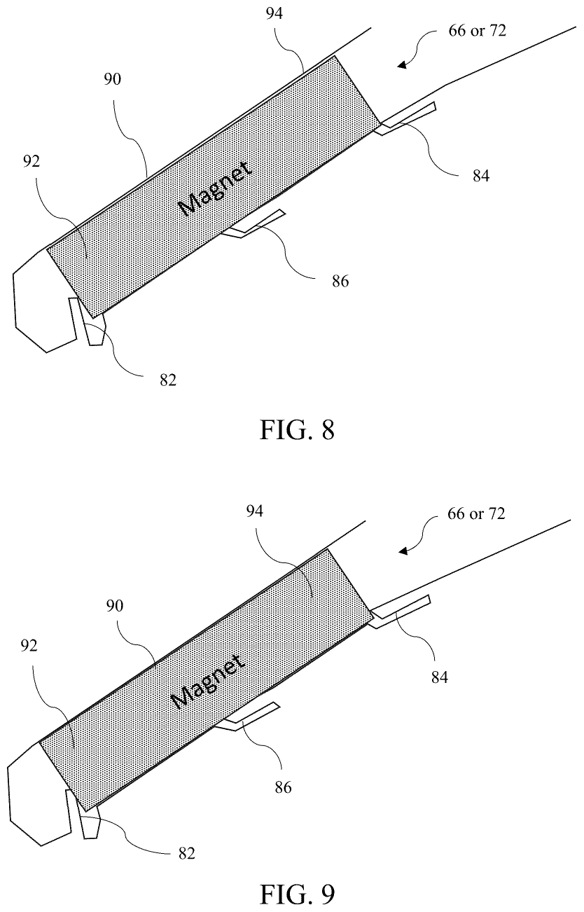

FIGS. 6-9 illustrate several sequential stages of insertion of a permanent magnet into one of the magnet slots 66 or 72. In FIG. 6, the magnet 90 is positioned in a first position in a tapered section 88 of the magnet slot. A front portion 92 of the magnet is in the magnet slot, but a rear portion 94 of the magnet extends beyond the perimeter of the rotor plate body. In FIG. 7, the magnet has been moved further into the magnet slot to a second position. As the magnet 90 is moved from the first position to the second position, the retainer tab 84 is deflected out of the magnet slot by the front portion 92 of the magnet. In FIG. 8, the magnet has been moved into a third position. In the third position, the front portion 92 abuts stopper tab 82. The rear portion 94 continues to deflect retainer tab 84 out of the magnet slot. As the magnet 90 is moved from the second position to the third position, compressor tab 86 is also deflected out of the magnet slot by the magnet. FIG. 9 shows the position of the magnet 90 after the magnet is pushed against the stopper tab 82 deflecting the stopper tab along an axis of the magnet slot. The retainer tab 84 extends back into the magnet slot behind the rear portion 94 of the magnet. In this position, the retainer tab 84 prevent the magnet from sliding out of the magnet slot. The magnet 90 continues to deflect compressor tab 86 out of the magnet slot.

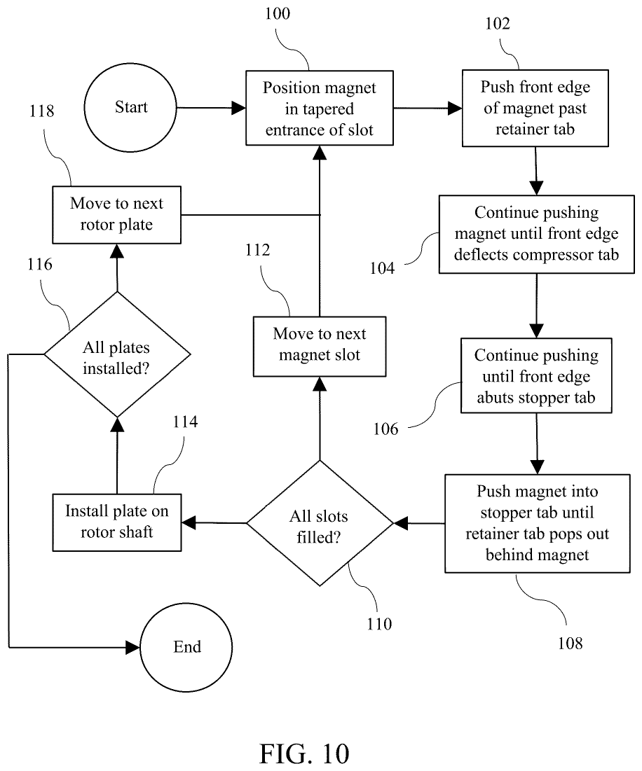

FIG. 10 is a flowchart for a process of assembling a rotor for a permanent magnet motor. At 100, a magnet is positioned in a tapped region of a magnet slot, as illustrated in FIG. 6. At 102, the magnet is pushed further into the magnet slot such that the front edge of the magnet moves past the retainer tab deflecting the retainer tab out of the magnet slot as illustrated in FIG. 7. At 104, the magnet is pushed yet further into the magnet slot such that the front edge of the magnet moves past the compressor tab deflecting the compressor tab out of the magnet slot. At 106, the magnet is pushed further into the magnet slot until the front edge of the magnet abuts the stopper tab as shown in FIG. 8. Throughout steps 104 and 106, the retainer tab remains pushed out of the magnet slot. At 108, the magnet is pushed to deflect the stopper tab until the magnet moves past the retainer tab, at which point the retainer tab springs back into the magnet slot. At this point, insertion of the magnet is complete. The retainer tab prevents the magnet from sliding back out of the magnet slot. The compressor tab remains deflected out of the magnet slot.

At 110, it is determined whether all magnet slots in the rotor plate have been filled. If not, another magnet is selected at 112 and the insertion process of steps 100-108 is performed for an unfilled magnet slot. If all magnet slots of the rotor plate have been filled at 110, then the rotor plate is installed on the rotor shaft at 114. At 116, it is determined whether all plates have been installed in the shaft. If not, another rotor plate is selected at 118 and the magnet insertion process of steps 100-114 is performed for that rotor plate.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A rotor plate comprising:
a body defining a plurality of magnet slots, each magnet slot extending diagonally from a perimeter of the body;
a plurality of stopper tabs, each stopper tab extending into one of the plurality of magnet slots; and
a plurality of retainer tabs, each retainer tab extending into one of the plurality of magnet slots and configured to deflect out of the magnet slot in response to partial insertion of a magnet and to return to its original position in response to complete insertion of the magnet.

2. The rotor plate of claim 1 wherein each stopper tab is configured to deflect along an axis of the respective magnet slot in response to complete insertion of the magnet.

3. The rotor plate of claim 1 wherein:
each magnet slot has an outer side towards the perimeter and an inner side opposite the outer side; and
at least one of the stopper tabs and the retainer tabs are located along the inner sides of the magnet slots.

4. The rotor plate of claim 3 wherein the stopper tabs and the retainer tabs are both located along the inner sides of the magnet slots.

5. The rotor plate of claim 1 further comprising a plurality of compressor tabs, each compressor tab extending into one of the magnet slots between a respective stopper tab and a respective retainer tab and configured to deflect out of the magnet slot in response to partial insertion of the magnet and to remain out of the slot with the magnet completely inserted.

6. The rotor plate of claim 5 wherein the compressor tabs are located on a same side of the magnet slots as the stopper tabs and the retainer tabs.

7. The rotor plate of claim 1, wherein each of the magnet slots includes a tapered section between the perimeter of the body and one of the plurality of retainer tabs.

8. A rotor comprising:
a rotor plate defining at least one magnet slot, each magnet slot extending diagonally from a perimeter of the rotor plate;
at least one stopper tab, each stopper tab extending from the rotor plate into one of the at least one magnet slots;
at least one permanent magnet, each permanent magnet located in one of the at least one magnet slots abutting one of the stopper tabs; and
at least one retainer tab, each retainer tab extending diagonally from the rotor plate into one of the at least one magnet slots on an opposite end of a respective one of the permanent magnets from a respective one of the stopper tabs.

9. The rotor of claim 8 wherein the stopper tabs and the retainer tabs are integrally formed with the rotor plate.

10. The rotor of claim 8 further comprising at least one compressor tabs, each compressor tab located between a respective one of the stopper tabs and one of the retainer tabs and being deflected out of the magnet slot by one of the permanent magnets.

11. The rotor of claim 8, wherein each of the magnet slots includes a tapered section between the perimeter of the rotor plate and one of the retainer tabs.

12. The rotor of claim 8 wherein the rotor plate comprises:
a star-shaped portion; and
a plurality of wedge-shaped portions, each wedge-shaped portion fixed to the star-shaped portion by a respective radial link; wherein
each of the magnet slots is defined between the star-shaped portions and one of the plurality of wedge-shaped portions.

13. The rotor of claim 8 wherein the rotor plate comprises:
a star-shaped portion;
a plurality of V-shaped portions, each V-shaped portion fixed to the star-shaped portion by a respective first radial link; and
a plurality of wedge-shaped portions, each wedge-shaped portion fixed to one of the plurality of V-shaped portions by a respective second radial link; wherein
each magnet slot of a first subset of the plurality of magnet slots is defined between the star-shaped portions and one of the plurality of V-shaped portions; and
each magnet slot of a second subset of the plurality of magnet slots is defined between one of the plurality of V-shaped portions and one of the plurality of wedge-shaped portions.

14. A method of assembling a rotor comprising:
positioning a magnet in a first position with respect to a rotor plate wherein a front portion of the magnet is in a magnet slot of the rotor plate and a rear portion of the magnet extends beyond a perimeter of the rotor plate;
moving the magnet from the first position to a second position wherein, in the second position, the front portion deflects a retaining tab out of the magnet slot;
moving the magnet from the second position to a third position wherein, in the third position, the front portion abuts a stopper tab and the rear portion deflects the retaining tab out of the magnet slot; and
pushing the magnet against the stopper tab deflecting the stopper tab such that the retainer tab extends into the magnet slot to prevent the magnet from sliding out of the magnet slot.

15. The method of claim 14 wherein, in the second position, the magnet also deflects a compressor tab out of the magnet slot.

16. The method of claim 15 wherein the compressor tab remains deflected out of the magnet slot after pushing the magnet against the stopper tab.
